(19) United States
(12) Patent Application Publication
(10) Pub. No.: US 2019/0073804 A1
(43) Pub. Date: Mar. 7, 2019

(54) METHOD FOR AUTOMATICALLY RECOGNIZING ARTIFACTS IN COMPUTED-TOMOGRAPHY IMAGE DATA

(71) Applicant: Siemens Healthcare GmbH, Erlangen (DE)

(72) Inventor: Thomas ALLMENDINGER, Forchheim (DE)

(73) Assignee: Siemens Healthcare GmbH, Erlangen (DE)

(21) Appl. No.: 16/116,095

(22) Filed: Aug. 29, 2018

(30) Foreign Application Priority Data
Sep. 5, 2017 (EP) 17189328.2

(51) Int. Cl. G06T 11/00; G06F 15/18; G06N 3/08

(52) U.S. Cl. CPC G06T 11/008; G06F 15/18; G06T 2211/424; G06T 2211/416; G06T 2211/421; G06N 3/08

(57) ABSTRACT

A method is for recognizing artifacts in computed tomography image data. In an embodiment, the method includes acquisition of projection measurement data from a region under examination of a subject to be examined; reconstruction of image data on the basis of the projection measurement data; checking for the presence of an artifact in the image data using a trained recognition unit; recognition of an artifact type of an artifact that is present using a trained recognition unit; and output of the recognized artifact type.

### PRIORITY STATEMENT

The present application hereby claims priority under 35 U.S.C. § 119 to European patent application number EP17189328.2 filed Sep. 5, 2017, the entire contents of which are hereby incorporated herein by reference.

### FIELD

Embodiments of the invention generally relate to a method for artifact recognition, to a method for training a recognition unit, and to a processing unit, to a computed tomography system, to a computer program product, to a computer-readable medium, to a training unit, to a further computer program product, and to a further computer-readable medium.

### BACKGROUND

Computed tomography is an imaging technique that is used primarily for medical diagnosis and for examining materials. In computed tomography, for the purpose of acquiring image data in three-dimensional space, a radiation source, for instance an X-ray source, and a detector apparatus working in association with this source, rotate about a subject under examination. During the rotational movement, measurement data is acquired within an angular sector. The projection measurement data constitutes a multiplicity of projections containing information about the attenuation of the radiation through the subject under examination from different projection angles. A two-dimensional cross-sectional image or a three-dimensional volumetric image of the subject under examination can be computed from these projections. The projection measurement data is also referred to as raw data, or the projection measurement data can already have been preprocessed, for instance to reduce detector-dependent differences in attenuation intensity. Image data can then be reconstructed from this projection measurement data, for instance using what is known as filtered backprojection or using an iterative reconstruction method. If the subject under examination moves for instance during the acquisition, then the movement can cause blurring and artifacts in the reconstruction of the image data.

Numerous different procedures are known for scanning a subject under examination using a computed tomography system. For instance circular scans, sequential circular scans with feed, or spiral scans are used. Other forms of scans that are not based on circular movements are also possible, so for instance scans containing linear segments. At least one X-ray source and at least one oppositely located detector apparatus are used to acquire absorption data for the subject under examination from different acquisition angles, and suitable reconstruction techniques are used to convert by calculation this absorption data or projection measurement data collected in this way into cross-sectional images through the subject under examination.

Today, what is known as a filtered backprojection (FBP) technique or iterative reconstruction is used as a standard method for reconstructing computed tomography images from the projection measurement data of a computed tomography system. In the case of filtered backprojection techniques, the approximative way in which they work can cause problems with what are known as cone-beam artifacts, spiral artifacts, scanning artifacts, convolution artifacts, and limited-view artifacts. The filtered backprojection technique belongs to the group of approximative reconstruction methods. There is also the group of exact reconstruction methods, although this group is hardly used at the moment. The iterative techniques form a third group of reconstruction methods.

At least some of the above-mentioned limitations of filtered backprojection can be resolved by iterative reconstruction methods. First of all in such an iterative reconstruction method, initial image data is reconstructed from the projection measurement data. This can be done using a filtered backprojection technique, for example. The iterative reconstruction method then gradually generates improved image data. For example, a “projector”, a projection operator, which is meant to model mathematically the measurement system as closely as possible, can be used to generate synthetic projection data from the initial image data. The adjoint operator of the projector is then used to backproject the difference from the measurement signals, thereby reconstructing a residuum image, which is used to update the initial image. The updated image data can in turn be used in a next iteration step to generate new synthetic projection data by means of the projection operator, to form therefrom again the difference from the measurement signals, and to compute a new residuum image which again is used to improve the image data of the current iteration stage, and so on. Examples of iterative reconstruction methods are the algebraic reconstruction technique (ART), the simultaneous algebraic reconstruction technique (SART), iterative filtered backprojection (IFBP), or statistic iterative image reconstruction techniques.

Document DE 103 54 214 A1 discloses a method for generating tomographic cross-sectional images, in particular X-ray CT images, of a periodically moving subject having phases that alternate periodically between movement and rest, preferably of a heart, and discloses an imaging tomography apparatus for this purpose, wherein for the scan, a plurality of focus/detector combinations comprising planar detectors are moved on coaxial spiral paths, and movement signals from the moving subject are simultaneously measured for detecting movement phase and rest phase, and the time-correlation between the movement data and the detector output data is stored, and the detector output data from each detector, which represents a rest phase of the moving subject, is used to reconstruct independently from one another axial segment image stacks composed of subsegments of the spiral paths, and time-aligned segment image stacks composed of the n spiral paths of the n focus/detector combinations are summated for each complementary angle and slice-by-slice into 180° tomographic cross-sectional images, wherein the axial segment image stacks are reconstructed in a first step from double-tilt reconstruction planes, and in a second step are reformatted into axial segment image stacks, and detector data from a plurality of successive motion periods is used for this purpose.

Document DE 10 2015 218 928 A1 discloses a method for generating radiographic data from a subject under examination containing reduced calcium blooming. The radiographic data is based on X-ray projection data that has been acquired using an energy-selective X-ray detector involving at least two energy windows. The method comprises the step of determining a calcium component in the X-ray projection data by means of base material decomposition, wherein the calcium component defines the calcium-dependent portion of the X-ray attenuation caused by the subject under examination. The method also comprises the step of generating a mixed X-ray projection dataset containing a calcium component suppressed by a weighting factor of less than one, and reconstructing the radiographic data from the mixed projection dataset by applying a reconstruction algorithm, or the steps of reconstructing individual radiographic datasets for each of the energy windows using a reconstruction algorithm from the X-ray projection datasets, and of generating a mixed radiographic dataset by weighted addition of the first and the at least one second individual radiographic dataset, with weighting factors being selected for the individual image datasets such that a calcium component is suppressed in the mixed radiographic dataset.

Document DE 10 2015 206 362 B3 discloses a dynamic CT imaging method, in which method, projection measurement data is acquired from a region to be imaged of a subject under examination while simultaneously detecting in correlation the respiratory movement of the subject under examination. A phase of the respiratory movement is selected for which the image data is meant to be reconstructed. In addition, the phase projection measurement data associated with the selected phase is determined. Then transition regions of sub-images of the region to be imaged between successive respiratory cycles are reconstructed experimentally on the basis of a portion of the phase projection measurement data, and finally a standard reconstruction is performed using portions of the phase projection measurement data, which portions are associated with an optimum reconstruction, for each of the successive respiratory cycles.

### SUMMARY

The inventor has recognized as a problem that when using computed tomography systems, artifacts in the image data can arise as a result of technical defects in individual components, for instance in a detector channel or a detector module, aging, or partial failure of the detector, or as a result of physically induced effects such as, for example, beam hardening, the cone-beam effect, X-ray scattering, movement of the patient and other effects. Although the trained radiologist is normally able to recognize the artifacts as such, the radiologist usually cannot find a proper answer about the cause. This means that a service engineer or an applications specialist is often consulted. When there is a real defect in the equipment, the time and expense involved can be justified, but often simply effects intrinsic to computed tomography imaging are responsible for the artifact.

At the present time, artifacts are evaluated and assessed by human experts. For instance, a service engineer, an applications specialist or an expert in assessing the artifact can be consulted. The inventor has recognized that automated evaluation or pre-filtering of the cases is desirable, as is a mechanism that examines automatically in advance the images concerned and already classifies said images as far as possible.

Embodiments of the invention define a method for artifact recognition, a method for training a recognition unit, and a processing unit, a computed tomography system, a computer program product, a computer-readable medium, a training unit, a further computer program product, and a further computer-readable medium, which facilitate automatic artifact recognition.

Embodiments according to the invention are directed to a method for artifact recognition, a method for training a recognition unit, a processing unit, a computed tomography system, a computer program product, a computer-readable medium, a training unit, a further computer program product, and a further computer-readable medium.

At least one embodiment of the invention relates to a method for recognizing artifacts in computed-tomography image data comprising the steps of acquisition, reconstruction, checking, recognition, and output. In the acquisition step, projection measurement data from a region under examination of a subject to be examined is acquired. In the reconstruction step, image data is reconstructed on the basis of the projection measurement data. In the checking step, the image data is checked for the presence of an artifact by means of a trained recognition unit. In the recognition step, an artifact type of an artifact that is present is recognized by means of a trained recognition unit. In the output step, the recognized artifact type is output.

At least one embodiment of the invention also relates to a method for training a recognition unit for recognizing artifacts in computed-tomography image data, comprising the steps of generation and training. In the generation step, artifact image data containing at least one artifact is generated. In the training step, the recognition unit is trained on the basis of the artifact image data.

At least one embodiment of the invention also relates to a processing unit for recognizing artifacts in computed-tomography image data, for performing the method according to at least one embodiment of the invention for artifact recognition. The processing unit comprises an acquisition unit for acquiring projection measurement data from a region under examination of a subject to be examined, a reconstruction unit for reconstructing image data on the basis of the projection measurement data, a checking unit for checking for the presence of an artifact in the image data by means of a trained recognition unit, a recognition apparatus for recognizing an artifact type of an artifact that is present by means of a trained recognition unit, and an output unit for the output of the recognized artifact type.

At least one embodiment of the invention also relates to a computed tomography system comprising a processing unit. The method can advantageously perform the artifact recognition directly in the computed tomography system. Causes of the artifact can advantageously be recognized quickly. Artifact-affected acquisitions can advantageously be avoided.

At least one embodiment of the invention also relates to a computer program comprising program code for performing the method according to at least one embodiment of the invention for artifact recognition when the computer program is executed on a computer.

At least one embodiment of the invention also relates to a non-transitory computer-readable data storage medium comprising program code of a computer program for performing the method of at least one embodiment of the invention for artifact recognition when the computer program is executed on a computer.

At least one embodiment of the invention also relates to a training unit for training a recognition unit, comprising at least one processor for performing at least one embodiment of a method for training the recognition unit. The computed tomography system can comprise the training unit. The training unit may be a separate unit from the computed tomography system. The training unit can comprise a generating unit for generating artifact image data containing at least one artifact, and a training apparatus for training the recognition unit on the basis of the artifact image data. The training unit can advantageously receive training data via an interface, for instance from a storage medium or from a Cloud memory.

At least one embodiment of the invention also relates to a an apparatus for recognizing artifacts in computed tomography image data, comprising:
at least one processor configured to:

acquire projection measurement data from a region under examination of a subject to be examined,
reconstruct image data based upon the projection measurement data to produce reconstructed image data,
check for a presence of an artifact in the reconstructed image data, using trained recognition,
recognize an artifact type of an artifact, found to be present in the reconstructed image data during the check, and
output the artifact type recognized.

At least one embodiment of the invention also relates to a computer memory storing a program including program code, for performing at least one embodiment of the method, when the program is executed on a computer.

At least one embodiment of the invention also relates to a further non-transitory computer-readable data storage medium comprising further program code of a further computer program for performing at least one embodiment of the method for training the recognition unit when the further computer program is executed on a computer.

### BRIEF DESCRIPTION OF THE DRAWINGS

Example embodiments of the invention are described in greater detail below with reference to drawings, in which:

FIG. 1 is a schematic diagram of the method according to an embodiment of the invention for artifact recognition;

FIG. 2 is a schematic diagram of the method according to an embodiment of the invention for training the recognition unit;

FIG. 3 is a schematic diagram of the regions in the image data; and

FIG. 4 shows schematically a design of a computed tomography apparatus according to an embodiment of the invention.

### DETAILED DESCRIPTION OF THE EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated. The present invention, however, may be embodied in many alternate forms and should not be construed as limited to only the example embodiments set forth herein.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Before discussing example embodiments in more detail, it is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments of the present invention. This invention may, however, be embodied in many alternate forms and should not be construed as limited to only the embodiments set forth herein.

Units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one embodiment of the invention relates to the non-transitory computer-readable storage medium including electronically readable control information (procesor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

At least one embodiment of the invention relates to a method for recognizing artifacts in computed-tomography image data comprising the steps of acquisition, reconstruction, checking, recognition, and output. In the acquisition step, projection measurement data from a region under examination of a subject to be examined is acquired. In the reconstruction step, image data is reconstructed on the basis of the projection measurement data. In the checking step, the image data is checked for the presence of an artifact by means of a trained recognition unit. In the recognition step, an artifact type of an artifact that is present is recognized by means of a trained recognition unit. In the output step, the recognized artifact type is output.

In an embodiment, in the reconstruction step, image data is reconstructed from the projection measurement data, for instance using filtered backprojection or iterative reconstruction. The image data may comprise a slice image, a plurality of, in particular adjacent, slice images or a plurality of time-dependent slice images.

In an embodiment, in the checking step, a check is performed to determine whether an artifact is present in the image data. If an artifact is present, the checking step may also comprise localizing the artifact in the image data. For example, the position of the artifact can be localized by identifying the slice or the slice image in the image data and/or the position of the artifact can be localized within a slice or the slice image in the image data. In addition, the extent of the artifact can be localized. In the recognition step, the artifact type is recognized, where the artifact type can depend on localization, for example. The artifact type can be determined in particular from a plurality of known artifact types.

The inventor has recognized that modern methods of machine supervised learning can be used to facilitate artifact recognition by means of artifact-affected and complementary artifact-free training data in order to detect and assess automatically, for instance in later use, technical defects in clinical images. This assessment or detection can include automatic clarifications to the radiologist relating to individual unrecognized structures beyond the anatomy, for instance movement of the subject under examination, beam hardening, calcium blooming and others. This assessment or detection can be used advantageously for a daily analysis of the clinical data in order to detect defects or first signs of technical problems. A regular inspection using artifact recognition can generate, in the event of an identified fault, an automatic message to the service engineer, for instance, who can rectify the defect before the customer complains. The artifact type and/or cause of the artifact can be output advantageously. For example, sporadic detector-channel dropouts can produce artifacts only in occasional images, with these artifacts being present, for example, in the region of the image data outside the subject under examination, for instance in the region of the air around the subject under examination. Hence a defect or artifact is included that is not immediately relevant to the radiologist but for which it is still desirable to rectify the fault. In addition to the use in the clinical environment, a use in producing computed tomography systems is also advantageous. The automatic analysis of the image data can be used to deduce in a simplified form the underlying cause of the fault, for instance the number or position of the defective detector module, and hence it is possible advantageously to speed up the procedures in the production process and/or in clinical operation.

The checking step can be performed in particular before the recognition step. In the checking step, the image data or the slice image can be partitioned or characterized in order to check whether or not an artifact is present. A multiplicity of methods can be used here, for instance FFT, wavelet or others. For example, the image data can be partitioned or divided into regions, for instance ROIs. At least one characteristic can be determined for at least one region, in particular for a plurality of regions and preferably for each region.

For example, in particular each slice image can be partitioned into, for instance 150, circular regions, called ROIs (regions of interest), with the arrangement and radii modeling the form of an iris in the eye; see for details the publication by Gomes, Herman M., and Robert B. Fisher, “Primal sketch feature extraction from a log-polar image.” Pattern Recognition Letters 24.7 (2003): 983-992, the entire contents of which are hereby incorporated herein by reference. Then for the slice image, the mean HU value, the minimum HU value, the maximum HU value or another characteristic can be determined as the first characteristic in the, for instance 150, regions.

In addition, a gradient image, for instance one in the X-direction and one in the Y-direction, can be derived from the slice image. The gradient image comprises the gradients of the HU values for, for instance, each region, for example along an X-direction or Y-direction, in the slice image. In each gradient image, for instance 150 ROI values for the magnitude of the mean value of the gradient within a region can be determined as a second characteristic for the gradient image in the X-direction, and as a third characteristic for the gradient image in the Y-direction. Each image can thereby be characterized, for example, by all or a subset of the first, second and third characteristics, which means, for instance, that all the 450 ROI values can be used for a slice image. The checking step can comprise a threshold-based decision about the presence of the artifact. For example, if a subset of the characteristics exceeds a threshold value, the presence or absence of the artifact can be determined thereby.

In the recognition step, an artifact type can be recognized, for example, on the basis of the at least one characteristic. The artifact type can be recognized on the basis of a spatial arrangement of characteristics, for instance above a threshold value. Recognizing the artifact type can be based in particular on the knowledge or experience of the recognition unit. In particular, a plurality of artifact types can be recognized.

Methods from the field of machine learning can be used advantageously to automate the recognition of artifacts in clinical image data, in particular caused by defects and physical effects. These methods can exploit the fact that already known causes, for instance detector faults, X-ray source faults or tube faults or others, can be impressed on existing raw data, for instance, during the generation of training data, and in turn images can be computed or reconstructed therefrom. The training data can be used as the basis for a supervised learning method, which ultimately as additional software can advantageously assist the radiologist at the apparatus in assessing the images. This automated assistance can prevent problems simply being notified. Moreover, automatic artifact recognition or analysis that has been carried out can be used to detect defects at the apparatus even before the radiologist, or before clinical data is affected. If necessary, a service request can be generated automatically as an output as what is known as predictive maintenance.

According to one embodiment of the invention, the trained recognition unit is based on a machine learning method, a statistical method, a mapping rule, mathematical functions, or an artificial neural network. The trained recognition unit can preferably be based on the method of random (decision) forests. Patterns or regularities from the training data can advantageously be applied to the image dataset. The recognition unit can use associations or weightings of features or characteristics of the image data for the checking and/or recognition.

Machine learning methods can refer to the artificial generation of knowledge from experience. An artificial system learns from examples in a training phase, and can generalize once the training phase is finished. The recognition unit can be adapted in this way. The use of machine learning methods can comprise recognizing patterns and regularities in the training data. After the training phase, the recognition unit can extract features or characteristics in previously unknown image data, for example. After the training phase, the recognition unit can recognize an artifact type on the basis of previously unknown image data, for example. A reliable method for artifact recognition can advantageously be derived from the knowledge of known training data. Recognition of an artifact or artifact type can advantageously be performed on the basis of the experiences of the recognition unit of patterns or regularities.

According to one embodiment of the invention, the recognition unit is trained using artifacts from the group comprising striped, ring-shaped, linear, band-like, shadowed, radial, noisy, spiral, and stepped. The recognition unit is advantageously able to differentiate between a plurality of artifact types.

According to one embodiment of the invention, the artifact type is one of physical artifact, defect artifact and motion artifact. The physical artifact can comprise a hardening artifact, a scattering artifact, a projection scanning artifact, a metal artifact, a (calcium) blooming artifact, or a partial-volume artifact. The defect artifact can comprise an artifact caused by a defect in the image acquisition system, in particular in the X-ray detector or the X-ray source. The motion artifact can comprise a patient artifact, a body movement artifact of the subject under examination, a cardiac movement artifact or a respiratory artifact. It is advantageously possible to differentiate between a plurality of artifacts. The artifact type may allow the cause of the artifact to be inferred directly. The physical artifact can be attributed to a physical cause. The defect artifact can be attributed to a technical cause. The motion artifact can be attributed to a patient-related cause.

According to one embodiment of the invention, the output also comprises a technical cause, physical cause or patient-related cause of the artifact type. The user can advantageously identify the cause of the artifact reliably, and, if applicable, can personally remove the cause, subsequently allowing an acquisition to be performed that contains fewer artifacts or no artifacts.

According to one embodiment of the invention, the technical cause is one of non-linearity or defect in the detector, instability of the X-ray source focus, and incorrect calibration. A non-linearity can be caused, for instance, by a temperature change of the X-ray detector or a change in the polarization state of the X-ray detector. The instability of the X-ray source focus can be caused, for example, by aging effects of the X-ray source. The cause of the artifact can advantageously be attributed reliably to a technical component. It is advantageously possible to remove the technical cause rapidly. The defective technical component can advantageously be identified or localized.

At least one embodiment of the invention also relates to a method for training a recognition unit for recognizing artifacts in computed-tomography image data, comprising the steps of generation and training. In the generation step, artifact image data containing at least one artifact is generated. In the training step, the recognition unit is trained on the basis of the artifact image data.

In an embodiment, in the generation step, an artifact can be impressed on existing clinical data by simulation on the basis of a selection of a plurality of possible causes of artifacts, to form artifact image data. In the generation step, artifact-affected image data can be acquired by a computed tomography system. In the generation step, artifact-affected image data can be generated by simulation. In addition, a plurality of artifacts can be impressed on the clinical data. The artifact image data can be generated on the basis of artifact-free image data by manipulating the raw data that forms the basis of the image data and reconstructing afresh the manipulated raw data. The artifact image data comprises the effect of, for instance, non-linearities in the detector, instabilities of the focus, or incorrect calibration or incorrect calibration tables for the X-ray detector and/or the X-ray source. It is thereby possible to generate a large amount of training data, which training data comprises image data in error-free or artifact-free form and image data containing various artifacts. The training data is thereby suitable for modern methods of machine supervised learning in order to detect and assess automatically in later use, technical defects in clinical images.

For example, an artifact based on a defect in a detector module can be simulated on the basis of a non-linearity of the signal behavior in the raw data of the training data. The training data can also comprise the unadulterated, artifact-free image data.

For example, in particular each slice image can be partitioned into, for instance 150, circular regions, called ROIs (regions of interest), with the arrangement and radii modeling the form of an iris in the eye. Then for the slice image, the mean HU value, the minimum HU value, the maximum HU value or another characteristic can be determined as the first characteristic in the, for instance 150, regions.

In addition, a gradient image, for instance one in the X-direction and one in the Y-direction, can be derived from the slice image. In each gradient image, for instance 150 ROI values for the magnitude of the mean value of the gradient value within a region can be determined as a second characteristic for the gradient image in the X-direction, and as a third characteristic for the gradient image in the Y-direction. Each image can thereby be characterized, for example, by all or a subset of the first, second and third characteristics, which means, for instance, that all the 450 ROI values can be used for a slice image.

A multiplicity of clinical images, for example 2000, can each be characterized with and without artifact in the manner described above, and the recognition unit can be trained on the basis thereof using a machine learning method. Without loss of generality, a random (decision) forest can be selected as the method on the basis of the advantageous robustness, which method shall be understood to mean the weighted sum of the outputs from a multiplicity of smaller decision trees. Typical values for the number of decision trees in a random (decision) forest lie in the order of 500 to 1000.

The evaluation of the reliability or stability of the trained recognition unit can be based on a ROC analysis performed on classified images that were not part of the training. An analysis of the creation of the random (decision) forest also allows the input parameters, for instance a characteristic, to be classified according to the particular importance to the final result.

In the training or adaptation step, the recognition unit can be adapted on the basis of the training data. The training step can comprise in particular a machine learning method, and can also comprise a statistical method, a mapping rule, or an artificial neural network. The statistical method can comprise, for example, fuzzy logic, a self-organizing map, resampling, pattern recognition or a support vector machine. The machine learning method can include aspects of data mining. The machine learning method can comprise a symbolic system or a sub-symbolic system, for instance an artificial neural network with or without regression. The machine learning can comprise supervised, semi-supervised, unsupervised, reinforcement or active learning. The machine learning method can comprise batch learning, in which all the training data is available simultaneously, and, for instance, the recognition unit learns patterns and regularities once all the training data has been processed. The machine learning can comprise a continuous, incremental or sequential learning method, in which development of the patterns and regularities is staggered in time. In the continuous, incremental or sequential learning method, the training data can be discarded after a single execution and, for instance, adaptation of weights. With batch learning or in the continuous, incremental or sequential learning method, the training data can be available in stored form and can be accessible repeatedly. The machine learning method can comprise, for example, deep learning methods or shallow learning methods. The knowledge from known training data can advantageously be applied to unknown image data. By virtue of the training, the recognition unit can advantageously facilitate reliable recognition of the artifact, the artifact type or the cause of the artifact. Image data from the method for artifact recognition can additionally be used to train the recognition unit, for instance to improve the statistical probabilities of the occurrence of features or characteristics by means of an ever larger database.

In addition, the generated image data, containing and not containing an artifact, can be stored as examples in a database, and made available to the user for learning purposes. Training of the radiologist can advantageously include the technical influencing factors in addition to the clinical and diagnostic aspects of the image.

According to one embodiment of the invention, the artifact image data is based on simulated artifact projection data or artifact-affected projection measurement data. Simulated artifact projection data can comprise solely the image information on the artifact. Projection measurement data, or raw data, that has been simulated or acquired by a computed tomography system can be used. Simulation can be used to impress an artifact on artifact-free projection measurement data acquired by a computed tomography system or on artifact-free simulated projection measurement data. Projection measurement data containing no artifacts or corrected for the artifact can be generated from artifact-affected projection measurement data. Artifact projection data can be generated or simulated from artifact-affected projection measurement data. Artifact-affected image data and artifact-free image data can advantageously be provided as training data for the acquisition of a subject under examination.

According to one embodiment of the invention, the method according to the invention also comprises the steps of acquisition, reconstruction, selection, generation, reconstruction, and training. In the acquisition step, projection measurement data that is largely free of artifacts is acquired, in particular by means of a computed tomography system. In the reconstruction step, image data that is largely free of artifacts is reconstructed on the basis of the projection measurement data that is largely free of artifacts. In the selection step, at least one artifact type is selected. In the generation step, in particular simulated, artifact projection data is generated for the at least one artifact type. In the reconstruction step, artifact image data is reconstructed on the basis of the projection measurement data and the artifact projection data. In the training step, the recognition unit is trained additionally on the basis of the image data that is largely free of artifacts. The effect of the subject under examination on the training can be reduced advantageously.

According to one embodiment of the invention, training comprises characterization of the artifact image data and/or the image data that is largely free of artifacts. The characterization can also be referred to as parameterization. In the characterization step, features or characteristics can be extracted from the artifact image data or the image data that is largely free of artifacts. Artifact image data or image data exhibiting the same artifact type, for instance, can be grouped on the basis of the extracted features. The characterization can comprise determining at least one characteristic. For example, the characteristic can be determined within a region. The training of the recognition unit can be based on the characteristic. The training data can advantageously be reduced to a matrix of characteristics. The matrix of characteristics can advantageously be used as an input parameter matrix, for instance in a machine learning method, in particular in a random (decision) forest. The recognition unit can advantageously be trained on the basis of predetermined features or characteristics. The characterization step can advantageously speed up the training process.

At least one embodiment of the invention also relates to a processing unit for recognizing artifacts in computed-tomography image data, for performing the method according to at least one embodiment of the invention for artifact recognition. The processing unit comprises an acquisition unit for acquiring projection measurement data from a region under examination of a subject to be examined, a reconstruction unit for reconstructing image data on the basis of the projection measurement data, a checking unit for checking for the presence of an artifact in the image data by means of a trained recognition unit, a recognition apparatus for recognizing an artifact type of an artifact that is present by means of a trained recognition unit, and an output unit for the output of the recognized artifact type.

At least one embodiment of the invention also relates to a computed tomography system comprising a processing unit. The method can advantageously perform the artifact recognition directly in the computed tomography system. Causes of the artifact can advantageously be recognized quickly. Artifact-affected acquisitions can advantageously be avoided.

At least one embodiment of the invention also relates to a computer program comprising program code for performing the method according to at least one embodiment of the invention for artifact recognition when the computer program is executed on a computer.

At least one embodiment of the invention also relates to a non-transitory computer-readable data storage medium comprising program code of a computer program for performing the method of at least one embodiment of the invention for artifact recognition when the computer program is executed on a computer.

At least one embodiment of the invention also relates to a training unit for training a recognition unit, comprising at least one processor for performing at least one embodiment of a method for training the recognition unit. The computed tomography system can comprise the training unit. The training unit may be a separate unit from the computed tomography system. The training unit can comprise a generating unit for generating artifact image data containing at least one artifact, and a training apparatus for training the recognition unit on the basis of the artifact image data. The training unit can advantageously receive training data via an interface, for instance from a storage medium or from a Cloud memory.

At least one embodiment of the invention also relates to a further computer program comprising further program code for performing at least one embodiment of the method for training the recognition unit when the further computer program is executed on a computer.

At least one embodiment of the invention also relates to a further non-transitory computer-readable data storage medium comprising further program code of a further computer program for performing at least one embodiment of the method for training the recognition unit when the further computer program is executed on a computer.

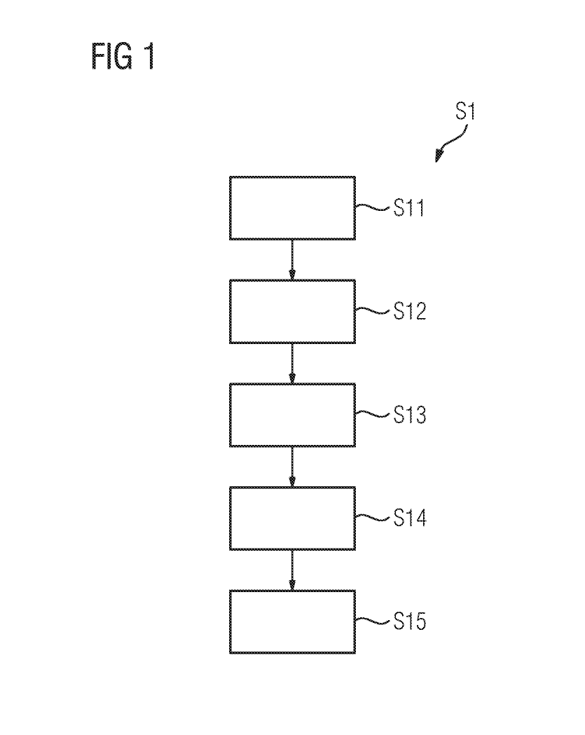

FIG. 1 shows an example embodiment of the method S1 according to the invention for artifact correction. The method S1 according to the invention for recognizing artifacts in computed-tomography image data comprises the steps of acquisition S11, reconstruction S12, checking S13, recognition S14, and output S15. In the acquisition step S11, projection measurement data from a region under examination of a subject to be examined is acquired. In the reconstruction step S12, image data is reconstructed on the basis of the projection measurement data. In the checking step S13, a trained recognition unit is used to check the image data for the presence of an artifact. In the recognition step S14, a trained recognition unit is used to recognize an artifact type of an artifact that is present. In the output step S15, the recognized artifact type is output.

In the reconstruction step S12, image data is reconstructed from the projection measurement data, for instance using filtered backprojection or iterative reconstruction. The image data comprises a slice image, a plurality of in particular adjacent slice images or a plurality of time-dependent slice images.

In the checking step S13, a check is performed to determine whether an artifact is present in the image data. If an artifact is present, the checking step S13 may also comprise localizing the artifact in the image data. For example, the position of the artifact is localized by identifying the slice or the slice image in the image data and/or the position of the artifact is localized within a slice or the slice image in the image data. In addition, the extent of the artifact can be localized. The checking step S13 is performed in particular before the recognition step. In the checking step S13, the image data or the slice image can be partitioned or characterized in order to check whether or not an artifact is present. A multiplicity of methods can be used here, for instance FFT, wavelet or others. For example, the image data can be partitioned or divided into regions, for instance ROIs.

In the recognition step S14, the artifact type is recognized, where the artifact type can depend on localization, for example. The artifact type is determined in particular from a plurality of known artifact types.

For example, in particular each slice image of the image data is partitioned into, for instance 150, circular regions, called ROIs (regions of interest), with the arrangement and radii modeling the form of an iris in the eye; details are shown in FIG. 3. Then for the slice image, the mean HU value, the minimum HU value, the maximum HU value or another characteristic can be determined as the first characteristic in the, for instance 150, regions.

In addition, a gradient image, one in the X-direction and one in the Y-direction, can be derived from the slice image. In each gradient image, for instance 150 ROI values for the magnitude of the mean value of the gradient value within a region are determined as a second characteristic for the gradient image in the X-direction, and as a third characteristic for the gradient image in the Y-direction. Each image is thereby characterized, for example, by all or a subset of, the first, second and third characteristics, which means, for instance, that all the 450 ROI values can be used for a slice image.

In the recognition step S14, an artifact type can be recognized, for example, on the basis of the at least one characteristic. The artifact type can be recognized on the basis of a spatial arrangement of characteristics, for instance above a threshold value. Recognizing the artifact type can be based in particular on the knowledge or experience of the recognition unit.

The trained recognition unit is based on a machine learning method, a statistical method, a mapping rule, mathematical functions, or an artificial neural network. The trained recognition unit is preferably based on the method of random (decision) forests.

Machine learning methods refer to the artificial generation of knowledge from experience. An artificial system learns from examples in a training phase, and can generalize once the training phase is finished. The recognition unit is adapted in this way during the training. The use of machine learning methods comprises recognizing patterns and regularities in the training data. After the training phase, the recognition unit can extract features or characteristics in previously unknown image data, for example. After the training phase, the recognition unit recognizes an artifact type on the basis of previously unknown image data, for example. The recognition unit is trained using artifacts from the group comprising striped, ring-shaped, linear, band-like, shadowed, noisy, radial, spiral, and stepped.

The artifact type is one of physical artifact, defect artifact and motion artifact. The physical artifact can comprise a hardening artifact, a scattering artifact, a projection scanning artifact, a metal artifact, a (calcium) blooming artifact, or a partial-volume artifact. The defect artifact comprises an artifact caused by a defect in the image acquisition system, in particular in the X-ray detector or the X-ray source. The motion artifact comprises a patient artifact, a body movement artifact of the subject under examination, a cardiac movement artifact or a respiratory artifact. The artifact type allows the cause of the artifact to be inferred directly. The physical artifact can be attributed to a physical cause. The defect artifact can be attributed to a technical cause. The motion artifact can be attributed to a patient-related cause.

The output S15 can also comprise the output of a technical cause, a physical cause or a patient-related cause of the artifact type. The technical cause is one of non-linearity or defect in the detector, instability of the X-ray source focus, and incorrect calibration. A non-linearity can be caused, for instance, by a temperature change of the X-ray detector or a change in the polarization state. The instability of the X-ray source focus can be caused, for example, by aging effects of the X-ray source. The technical component underlying the technical cause can be localized or identified, for instance the number or position of the defective detector module.

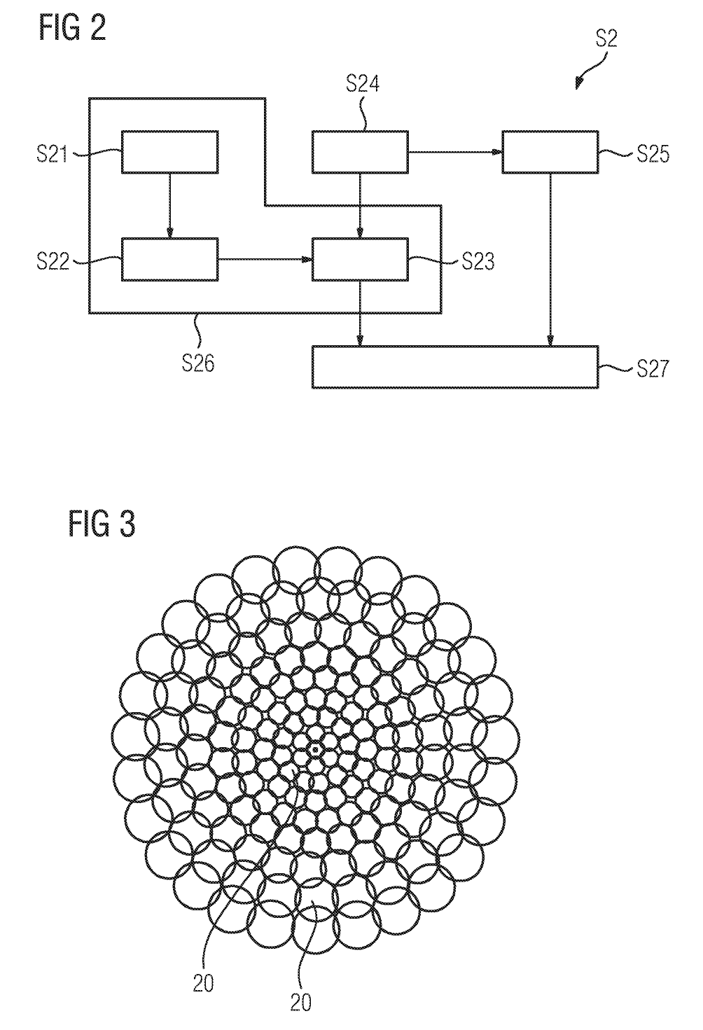

FIG. 2 shows an example embodiment of the method S2 according to the invention for training the recognition unit. The method S2 for training a recognition unit for recognizing artifacts in computed-tomography image data comprises the successive steps of generation S26 and training S27. In the generation step S26, artifact image data containing at least one artifact is generated. In the training step S27, the recognition unit is trained on the basis of the artifact image data.

In the generation step S26, an artifact is impressed on existing clinical data by simulation on the basis of a selection of a plurality of possible causes of artifacts, to form artifact image data. In the generation step S26, artifact-affected image data is generated by simulation. Additionally or alternatively, a plurality of artifacts can be impressed on the clinical data. The artifact image data can be generated on the basis of artifact-free image data by manipulating the raw data that forms the basis of the image data and reconstructing afresh the manipulated raw data. The artifact image data comprises the effect of, for instance, non-linearities in the detector, instabilities of the focus, or incorrect calibration or incorrect calibration tables for the X-ray detector and/or the X-ray source. It is thereby possible to generate a large amount of training data, which training data comprises image data in error-free or artifact-free form and artifact-affected image data containing various artifacts. For example, an artifact based on a defect in a detector module can be simulated on the basis of a non-linearity of the signal behavior. The training data can also comprise the unadulterated, artifact-free image data.

In the adaptation or training step S27, the recognition unit is adapted on the basis of the training data. The training step S27 can comprise in particular a machine learning method, and can also comprise a statistical method, a mapping rule, or an artificial neural network.

The artifact image data is preferably based on simulated artifact projection data. Simulated artifact projection data in particular comprises solely the image information on the artifact. Projection measurement data or raw data acquired by a computed tomography system is preferably used. Simulation is used in particular to impress an artifact on artifact-free projection measurement data acquired by a computed tomography system.

The method S2 can also comprise the steps of acquisition S24, reconstruction S25 of artifact-free projection measurement data, selection S21, and reconstruction S23 of artifact image data. The generation S26 of artifact image data can comprise the steps of selection S21 of the artifact type, simulation S22 of the artifact projection data, and reconstruction S23 of the artifact image data.

In the acquisition step S24, projection measurement data that is largely free of artifacts is acquired by means of a computed tomography system. In the reconstruction step S25, image data that is largely free of artifacts is reconstructed on the basis of the projection measurement data that is largely free of artifacts.

In the selection step S21, at least one artifact type is selected. In the generation step S22, simulated artifact projection data is generated for the at least one artifact type. In the reconstruction step S23, artifact image data is reconstructed on the basis of the projection measurement data that is largely free of artifacts and the artifact projection data. In the training step S27, the recognition unit can be trained on the basis of the image data that is largely free of artifacts and on the basis of the artifact data.

The training S27 or parameterization can comprise characterization of the artifact image data and/or of the image data that is largely free of artifacts. The characterization can comprise determining at least one characteristic. For example, the characteristic can be determined within a region. The training S27 of the recognition unit can be based on the characteristic. For example, in particular each slice image is partitioned into, for instance 150, circular regions, called ROIs (regions of interest), with the arrangement and radii modeling the form of an iris in the eye. Then for the slice image, the mean HU value, the minimum HU value, the maximum HU value or another characteristic can be determined as the first characteristic in the, for instance 150, regions.

In addition, a gradient image, one in the X-direction and one in the Y-direction, can be derived from the slice image. The gradient image can define the gradients on the basis of the HU values in the image data or in the slice image. In each gradient image, for instance 150 ROI values for the magnitude of the mean value of the gradient value within a region are determined as a second characteristic for the gradient image in the X-direction, and as a third characteristic for the gradient image in the Y-direction. Each image is thereby characterized, for example, by all or a subset of, the first, second and third characteristics, which means, for instance, that all the 450 ROI values can be used for a slice image.

The training data can be generated from a multiplicity of clinical images, for example 2000, and in each case characterized with and without artifact in the manner described above. The recognition unit can be trained by a machine learning method on the basis thereof. For example, a random (decision) forest is selected as the method, which method shall be understood to mean the weighted sum of the outputs from a multiplicity of smaller decision trees. The decision trees can be associated with the characteristics, or the characteristics can be used as the input parameters for the decision trees. Typical values for the number of decision trees in a random (decision) forest lie in the order of 500 to 1000.

The evaluation of the reliability or stability of the trained recognition unit is based, for example, on a ROC analysis performed on classified images that were not part of the training. An analysis of the creation of the random (decision) forest also allows the input parameters, for instance a characteristic, to be classified according to the particular importance to the final result.

FIG. 3 shows an example embodiment of the regions 20 in the image data. The slice image of the image data is partitioned into, for instance 150, circular regions 20, called ROIs (regions of interest), with the arrangement and radii modeling the form of an iris in the eye. The diameter of the radii of the regions 20 increases from the center towards the edge of the slice image.

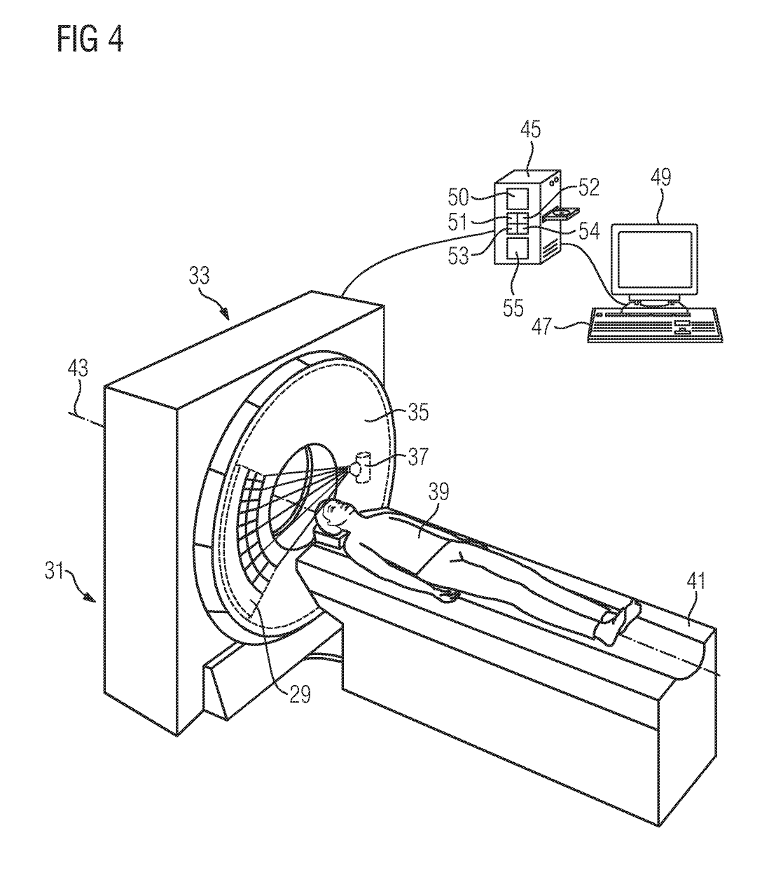

FIG. 4 shows an example embodiment of the computed tomography system 31 according to the invention for performing the method according to the invention for artifact recognition. The computed tomography system 31 contains a gantry 33 having a rotor 35. The rotor 35 comprises an X-ray source 37 and the detector device 29. The subject 39 under examination is supported on the patient couch 41 and can be moved along the axis of rotation z 43 by the gantry 33. A processing unit 45 is used for controlling and computing the slice images and for performing the method according to the invention, in particular for artifact recognition. An input device 47 and an output device 49 are connected to the processing unit 45. The processing unit 45 comprises an acquisition unit 51 for acquiring projection measurement data from a region under examination of a subject 39 to be examined, a reconstruction unit 52 for reconstructing image data on the basis of the projection measurement data, a checking unit 53 for checking for the presence of an artifact in the image data by means of a trained recognition unit, a recognition apparatus 54 for recognizing an artifact type of an artifact that is present by means of a trained recognition unit, and an output unit 55 for the output of the recognized artifact type. The processing unit 45 can comprise the training unit 50. A computer-readable data storage medium comprising program code of a computer program can be read or comprised by the processing unit in order to determine the method when the computer program is executed on a computer or on the processing unit 45.

Although the invention has been illustrated in greater detail using the preferred example embodiment, the invention is not limited by the disclosed examples, and a person skilled in the art can derive other variations therefrom without departing from the scope of protection of the invention.

The patent claims of the application are formulation proposals without prejudice for obtaining more extensive patent protection. The applicant reserves the right to claim even further combinations of features previously disclosed only in the description and/or drawings.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

None of the elements recited in the claims are intended to be a means-plus-function element within the meaning of 35 U.S.C. § 112(f) unless an element is expressly recited using the phrase “means for” or, in the case of a method claim, using the phrases “operation for” or “step for.”

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for recognizing artifacts in computed tomography image data, comprising:
acquiring projection measurement data from a region under examination of a subject to be examined;
reconstructing of image data based upon the projection measurement data to produce reconstructed image data;
checking for a presence of an artifact in the reconstructed image data, using a trained recognition unit;
recognizing an artifact type of an artifact, found to be present in the reconstructed image data during the checking; and
outputting the artifact type recognized.

2. The method of claim 1, wherein the trained recognition unit, used in the checking, is based on a machine learning method, a statistical method, a mapping rule, mathematical functions, or an artificial neural network.

3. The method of claim 1, wherein the trained recognition unit, used in the checking, is trained using artifacts from a group comprising striped, ring-shaped, linear, band-like, shadowed, radial, noisy, spiral, and stepped.

4. The method of claim 1, wherein the artifact type is one of physical artifact, defect artifact and motion artifact.

5. The method of claim 1, wherein the outputting includes a technical cause, a physical cause or a patient-related cause of the artifact type recognized.

6. The method of claim 5, wherein the technical cause is one of non-linearity in a detector or defect in the detector, instability of an X-ray source focus, and incorrect calibration.

7. A method for training a recognition unit for recognizing artifacts in computed tomography image data, comprising:
generating artifact image data containing at least one artifact; and
training a recognition unit, usable for checking for a presence of an artifact, based upon the artifact image data generated.

8. The method of claim 7, wherein the artifact image data is based on simulated artifact projection data or artifact-affected projection measurement data.

9. The method of claim 7, further comprising:
acquiring projection measurement data, the projection measurement data being largely free of artifacts;
reconstructing image data, the image data being largely free of artifacts, based upon the projection measurement data acquired;
selecting at least one artifact type;
generating artifact projection data for the at least one artifact type selected;
reconstructing artifact image data based upon the projection measurement data acquired and the artifact projection data generated, the training of the recognition unit including additionally training the recognition unit based upon the image data reconstructed, the image data reconstructed being largely free of artifacts.

10. The method of claim 7, wherein the training includes characterizing at least one of the artifact image data generated, the artifact image data containing at least one artifact, and the image data, the image data being largely free of artifacts.

11. A processing unit for recognizing artifacts in computed tomography image data, comprising:
an acquisition unit to acquire projection measurement data from a region under examination of a subject to be examined;
a reconstruction unit to reconstruct image data based upon the projection measurement data acquired by the acquisition unit;
a checking unit to check for a presence of an artifact in the image data, reconstructed by the reconstruction unit, using a trained recognition unit;
a recognition unit to recognize an artifact type of an artifact present, found to be present in the image data reconstructed; and
an output unit to output the artifact type recognized.

12. A computed tomography system comprising the processing unit of claim 11.

13. A non-transitory computer memory storing a program including program code, for performing the method of claim 1 when the program is executed on a computer.

14. A non-transitory computer-readable data storage medium comprising program code of a computer program for performing the method of claim 1 when the computer program is executed on a computer.

15. A training unit for training a recognition unit for recognizing artifacts in computed tomography image data, comprising:
at least one processor to
generate artifact image data containing at least one artifact; and
train a recognition unit, usable for checking for a presence of an artifact, based upon the artifact image data generated.

16. The method of claim 2, wherein the artifact type is one of physical artifact, defect artifact and motion artifact.

17. The method of claim 2, wherein the outputting includes a technical cause, a physical cause or a patient-related cause of the artifact type recognized.

18. The method of claim 9, wherein the generating includes
generating simulated artifact projection data for the at least one artifact type selected.

19. The method of claim 8, further comprising:
acquiring projection measurement data, the projection measurement data being largely free of artifacts;
reconstructing image data, the image data being largely free of artifacts, based upon the projection measurement data acquired;
selecting at least one artifact type;
generating artifact projection data for the at least one artifact type selected;
reconstructing artifact image data based upon the projection measurement data acquired and the artifact projection data generated, the training of the recognition unit including additionally training the recognition unit based upon the image data reconstructed, the image data reconstructed being largely free of artifacts.

20. The method of claim 9, wherein the training includes characterizing at least one of the artifact image data generated, the artifact image data containing at least one artifact, and the image data, the image data being largely free of artifacts.

21. An apparatus for recognizing artifacts in computed tomography image data, comprising:
at least one processor configured to:
acquire projection measurement data from a region under examination of a subject to be examined,
reconstruct image data based upon the projection measurement data to produce reconstructed image data,
check for a presence of an artifact in the reconstructed image data, using trained recognition,
recognize an artifact type of an artifact, found to be present in the reconstructed image data during the check, and
output the artifact type recognized.

22. A computed tomography system comprising the apparatus of claim 21.

23. A non-transitory computer memory storing a program including program code, for performing the method of claim 7 when the program is executed on a computer.

24. A non-transitory computer-readable data storage medium comprising program code of a computer program for performing the method of claim 7 when the computer program is executed on a computer.
